(19) United States
(12) Patent Application Publication
(10) Pub. No.: US 2004/0199279 A1
(43) Pub. Date: Oct. 7, 2004

(54) Equipment utilization optimization system and method applicable to multiple microelectronic fabrication facilities

(75) Inventors: Shinn-Chih Wang, Yunlin (TW); Chien-Hung Shen, Shinying City (TW); Ming-Hsiu Hsieh, Ban-Chim City (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/407,084

(22) Filed: Apr. 3, 2003

(51) Int. Cl. G06F 19/00

(52) U.S. Cl. 700/99

(57) ABSTRACT

Each of a method for fabricating a single microelectronic product within a plurality of fabrication facilities and a system for fabricating the single microelectronic product within the plurality of fabrication facilities employs a benchmarking of a tool utilization factor for a specific comparable tool group employed for fabricating the single microelectronic product. The benchmarking provides for development and implementation of revised tool operating procedures within the specific comparable tool group such as to effect optimized tool utilization factors within the specific comparable tool group.

### BACKGROUND OF THE INVENTION

1. Field of the Invention

The present invention relates generally to systems and methods for fabricating microelectronic products. More particularly, the present invention relates systems and methods for efficiently fabricating microelectronic products.

2. Description of the Related Art

Microelectronic products are typically complex products which comprise microelectronic devices connected and interconnected with patterned conductor layers which in turn are separated by dielectric layers. Microelectronic products are fabricated in facilities which often employ considerable numbers of sophisticated production tools.

Since microelectronic product fabrication often involves sophisticated production techniques and tooling distributed over multiple fabrication facilities for fabricating large numbers of microelectronic products, unique challenges often exist for efficiently fabricating microelectronic products.

It is thus desirable in the microelectronic product fabrication art to provide systems and methods for efficiently fabricating microelectronic products within multiple microelectronic product fabrication facilities.

It is towards the foregoing object that the present invention is directed.

Various apparatus, systems and methods have been disclosed in the microelectronic product fabrication art for efficiently fabricating microelectronic products.

Included but not limiting among the apparatus, systems and methods are those disclosed in Kraft, in U.S. Pat. No. 5,528,510 (an apparatus and method for determining and optimizing production tool performance when fabricating microelectronic products).

Desirable are apparatus, systems and methods for efficiently fabricating microelectronic products within multiple microelectronic product fabrication facilities.

It is towards the foregoing object that the present invention is directed.

### SUMMARY OF THE INVENTION

A first object of the invention is to provide a system and a method for fabricating a microelectronic product within multiple microelectronic product fabrication facilities.

A second object of the invention is to provide a system and a method in accord with the first object of the invention, wherein the system and the method provide for efficient fabrication of the microelectronic product within the multiple microelectronic product fabrication facilities.

In accord with the objects of the invention, the invention provides a system and a method for efficiently fabricating a microelectronic product.

In accord with the invention, the method first provides a plurality of microelectronic fabrication facilities comprising a plurality of tools employed for fabricating a single microelectronic product, where the plurality of tools is divided into a series of comparable tool groups. The invention also provides for determining for the plurality of tools a corresponding plurality of tool utilization factors when fabricating the single microelectronic product within the plurality of microelectronic fabrication facilities. The method further provides for comparing a plurality of tool utilization factors for a specific comparable tool group to define an optimized tool utilization factor for the specific comparable tool group. Finally, the method provides for developing and implementing revised operating procedures for the plurality of tools within the specific comparable tool group such that each tool within the specific comparable tool group operates at a tool utilization factor which approximates the optimized tool utilization factor for the specific comparable tool group.

The invention provides a system and a method for efficiently fabricating a microelectronic product within multiple microelectronic product fabrication facilities.

The system and the method realize the foregoing object by employing a benchmarking of a tool utilization factor with respect to a specific comparable tool group employed for fabricating a microelectronic product to provide an optimized tool utilization factor for the specific comparable tool group. Within the system and the method, the benchmarking of the tool utilization factor is provided such that revised operating procedures may be developed and implemented for a plurality of tools within the specific comparable tool group such that each tool within the specific comparable tool group operates at a tool utilization factor which approximates the optimized tool utilization factor for the specific comparable tool group.

### BRIEF DESCRIPTION OF THE DRAWINGS

The objects, features and advantages of the invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic diagram illustrating a series of components within a system in accord with the invention.

FIG. 2 shows a schematic block diagram illustrating progressive steps in accord with a method in accord with the invention.

FIG. 3 shows a schematic process flow diagram illustrating progressive steps in accord with the method in accord with the invention.

### DESCRIPTION OF THE PREFERRED EMBODIMENT

The invention provides a system and a method for efficiently fabricating a microelectronic product within multiple microelectronic product fabrication facilities.

The system and the method realize the foregoing object by employing a benchmarking of a tool utilization factor with respect to a specific comparable tool group employed for fabricating a microelectronic product to provide an optimized tool utilization factor for the specific comparable tool group. Within the system and the method, the benchmarking of the tool utilization factor is provided such that revised operating procedures may be developed and implemented for a plurality of tools within the specific comparable tool group such that each tool within the specific comparable tool group operates at a tool utilization factor which approximates the optimized tool utilization factor for the specific comparable tool group.

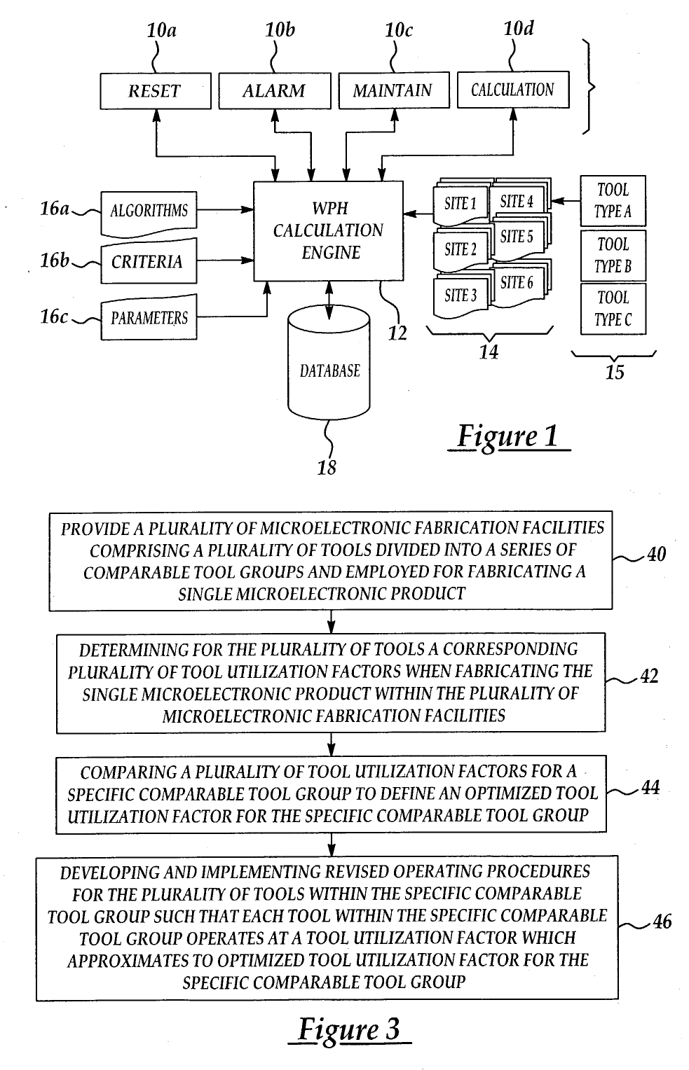

FIG. 1 shows a schematic diagram illustrating a series of components within a system in accord with the invention. As is understood by a person skilled in the art, the system in accord with the invention is a computer assisted system which as illustrated within FIG. 1 comprises a user (or client) interface portion, as well as a remainder portion which may be considered to be a server portion.

As illustrated in FIG. 1, the user interface portion provides a report capability 10a, an alarm capability 10b, a maintenance capability 10c and a calculation capability 10d for user access to the system through the user interface. Each of the foregoing capabilities is accessed by a user of the system through a user interface component which is not otherwise specifically illustrated within FIG. 1, but is otherwise generally conventional in the data processing and information technology art. Such user interface components may include, but are not limited to, graphical user interface components and keyboard user interface components.

As is further illustrated in FIG. 1, the remaining server portion of the system comprises a wafers per hour (WPH) calculation engine 12 which performs a wafer per hour productivity calculation upon data inputted into the wafers per hour calculation engine 12 from a series of tool types 15 (i.e., tool classifications or comparable tool groups) which is employed within a series of fabrication facilities 14 (i.e., defined as a series of sites). Also inputted into the wafers per hour calculation engine 12 is a series of algorithms 16a, criteria 16b and parameters 16c which is needed for providing wafers per hour calculations for the series of tool types 15 employed within the series of fabrication facilities 14 when fabricating a single microelectronic product within the series of fabrication facilities 14. Finally, FIG. 1 illustrates a database 18 which accumulates wafers per hour calculation results and related information from the wafer per hour calculation engine 12.

Within the invention, the series of fabrication facilities 14 is intended as a series of fabrication facilities within which is fabricated a single microelectronic product. The single microelectronic product may be selected from the group including but not limited to semiconductor products and ceramic substrate products. The series of fabrication facilities may be geographically localized, regionally (i.e., within an eastern global region or a western global region) geographically dispersed or globally geographically dispersed. The series of fabrication facilities 14 in an aggregate has contained therein a plurality of tools employed for fabricating the single microelectronic product. The plurality of tools is grouped into the series of tool types 15 which span at least in part the plurality of fabrication facilities 14. The series of tool types 15 may include tools selected from the groups including but not limited to wet chemical process tools, vacuum process tools, ion implant process tools, photolithographic process tools, deposition process tools, etch process tools and planarization process tools.

Within the invention, the algorithms 16a, the criteria 16b and the parameters 16c may be inputted into the wafers per hour calculation engine 12 either through the series of fabrication facilities 14 or by a user of the system through the user interface. Algorithms 16a are intended as mathematical equations needed for calculating a wafers per hour throughput productivity of a specific tool type. Criteria 16b and parameters 16c are intended as additional variables and constants which are required for a complete wafers per hour calculation, but which may not necessarily be provided as measured data from the series of tool types 15.

Finally, within the invention, the database 18 is otherwise generally conventional in the data processing and information technology art. The database 18 is intended to include both software components and hardware components needed for proper operation and storage of data and information within the database 18.

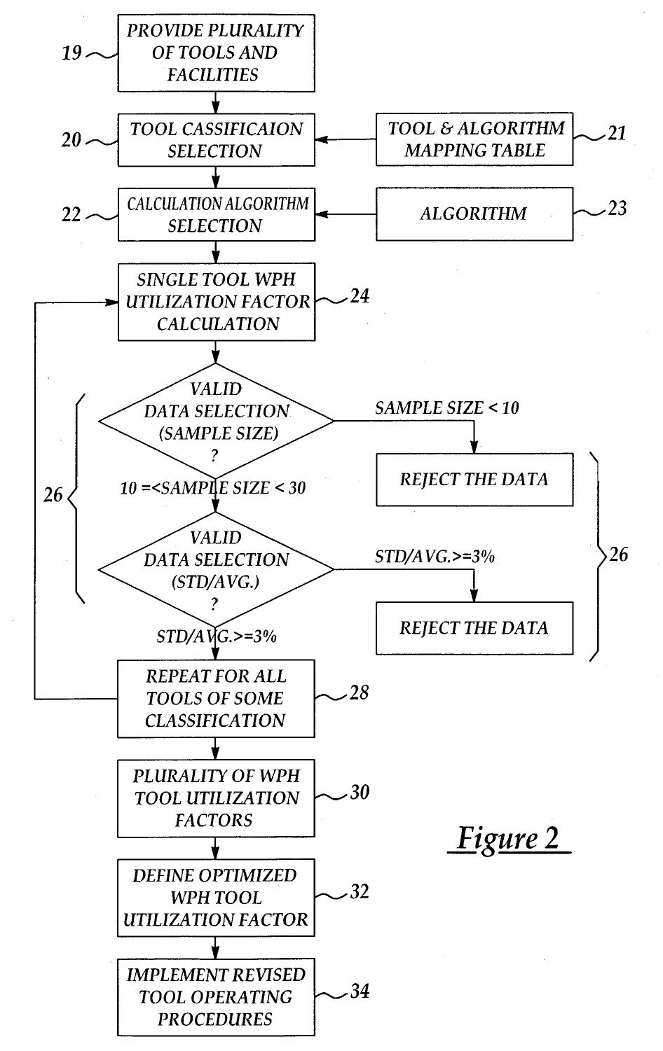

FIG. 2 shows a schematic block diagram illustrating a series of process steps in accord with a method in accord with the invention.

In accord with the block which corresponds with reference numeral 19, the method first provides a plurality of fabrication tools (in accord with the aggregate of the series of tool types 15 as illustrated in FIG. 1) and a plurality of fabrication facilities (in accord with the plurality of fabrication facilities 14 as illustrated in FIG. 1).

In accord with the blocks which correspond with reference numeral 20 and reference numeral 21, the method next provides for a tool classification selection incident to mapping all of the fabrication tools and their related algorithms within a mapping table. The tool and algorithm mapping table is intended to properly correlate a specific tool group with an acceptable wafers per hour calculation algorithm which may be employed for calculating a wafer per hour productivity tool utilization factor for each tool within the specific tool group.

In accord with the blocks which correspond with reference numeral 22 and reference numeral 23, a wafers per hour calculation algorithm is selected from a library of wafer per hour calculation algorithms which is provided by the various fabrication facilities, or otherwise by a user not specifically connected with any of the plurality of fabrication facilities. The invention provides for use of a single wafer per hour calculation algorithm within the method of the invention. Examples of specific algorithms which may be employed for calculating a wafer per hour utilization factor for a specific tool type may be found, for example and without limitation, within the reference cited within the Description of the Related Art, the teachings of which are incorporated herein fully by reference. In general, wafers per hour calculation algorithms will employ factors such as tool process run times, tool process loading/unloading times and tool batch sizes.

In accord with the block which corresponds with reference numeral 24, a wafers per hour calculation is undertaken for a specific tool within a specific tool group, after selection of an appropriate wafers per hour calculation algorithm.

In accord with the blocks which correspond with reference numeral 26, the wafers per hour calculation is validated and qualified for the specific tool within the specific tool group. The validation and qualification is undertaken with respect to both a sample size (i.e., between 10 and 30 samples) and a standard deviation (i.e., less than 3 percent).

In accord with the block which corresponds with reference numeral 28, repetitive additional wafers per hour tool utilization factor calculations are undertaken for all remaining tools within the specific tool group (i.e., tool classification).

In accord with the block which corresponds with reference numeral 30, and as a result of completion of the repetitive loop which includes the blocks which correspond with reference numerals 24, 26 and 28, a corresponding plurality of wafers per hour tool utilization factors is obtained for the series of fabrication tools within the specific tool group.

In accord with the block which corresponds with reference numeral 32, the plurality of wafers per hour tool utilization factors is compared and evaluated such as to define an optimized wafers per hour tool utilization factor which serves as a benchmark or goal for the series of fabrication tools within the specific tool group. Typically, the optimized wafers per hour tool utilization factor will be a wafers per hour tool utilization factor providing the highest wafers per hour throughput productivity.

Finally, in accord with the block which corresponds with reference numeral 34, the method provides for development and implementation of revised fabrication tool operating procedures such that a wafers per hour tool utilization factor for each of the fabrication tools within the series of fabrication tools more closely approximates the optimized wafers per hour tool utilization factor for the series of fabrication tools within the specific tool group (i.e., deviations from the optimized wafers per hour tool utilization factor are reduced).

FIG. 3 shows a schematic process flow diagram illustrating sequential process steps in accord with the method of the invention.

In accord with the block which corresponds with reference numeral 40, the method first provides a plurality of microelectronic fabrication facilities which comprises a plurality of tools employed for fabricating a single microelectronic product. Within the method, the plurality of tools is divided into a series of comparable tool groups.

Within the method as outlined in FIG. 3, the plurality of microelectronic fabrication facilities is intended as the plurality of fabrication facilities 14 as illustrated in FIG. 1. Similarly, the plurality of tools and the series of comparable tool groups is intended to correlate with the plurality of tools and the series of tool groups 15 as illustrated within FIG. 1.

In accord with the block which corresponds with reference numeral 42, there is then determined for the plurality of tools a corresponding plurality of tool utilization factors when fabricating the single microelectronic product within the plurality of microelectronic fabrication facilities.

Within the method as outlined in FIG. 3, the plurality of tool utilization factors is determined in accord with the schematic block diagram of FIG. 2, where the plurality of tool utilization factors is determined in terms of wafers per hour tool utilization factors.

In accord with the block which corresponds with reference numeral 44, a plurality of tool utilization factors for a specific comparable tool group is compared to define an optimized tool utilization factor for the specific comparable tool group.

Within the method as outlined in FIG. 3, the optimized tool utilization factor is generally intended as a maximum of the peak wafer per hour selection 28 as illustrated within the schematic block diagram of FIG. 2.

In accord with the block which corresponds with reference numeral 46, revised operating procedures are developed and implemented within the specific comparable tool group such that each tool within the specific comparable tool group operates at a tool utilization factor which approximates the optimized tool utilization factor for the specific comparable tool group.

In accord with the foregoing description, the present invention provides a system and a method for efficiently fabricating a single microelectronic product within a plurality of microelectronic fabrication facilities.

The system and the method realize the foregoing object by employing a benchmarking of a tool utilization factor with respect to a specific comparable tool group employed for fabricating a microelectronic product to provide an optimized tool utilization factor for the specific comparable tool group. Within the system and the method, the benchmarking of the tool utilization factor is provided such that revised operating procedures may be developed and implemented for a plurality of tools within the specific comparable tool group such that each tool within the specific comparable tool group operates at a tool utilization factor which approximates the optimized tool utilization factor for the specific comparable tool group.

As is understood by a person skilled in the art, the preferred embodiment of the invention is illustrative of the invention rather than limiting of the invention. Revisions and modifications may be made to components in accord with the preferred embodiment of the invention while still providing a system and a method in accord with the invention, further in accord with the accompanying claims.

What is claimed is:

1. A method for fabricating a microelectronic product comprising:
providing a plurality of microelectronic fabrication facilities comprising a plurality of tools employed for fabricating a single microelectronic product, the plurality of tools being divided into a series of comparable tool groups;
determining for the plurality of tools a corresponding plurality of tool utilization factors when fabricating the single microelectronic product within the plurality of microelectronic fabrication facilities;
comparing a plurality of tool utilization factors for a specific comparable tool group to define an optimized tool utilization factor for the specific comparable tool group; and
developing and implementing revised operating procedures for the plurality of tools within the specific comparable tool group such that each tool within the specific comparable tool group operates at a tool utilization factor which approximates the optimized tool utilization factor for the specific comparable tool group.

2. The method of claim 1 wherein the plurality of microelectronic fabrication facilities is regionally geographically dispersed.

3. The method of claim 1 wherein the plurality of microelectronic fabrication facilities is globally geographically dispersed.

4. The method of claim 1 wherein the microelectronic product is selected from the group consisting of a semiconductor product and a ceramic substrate product.

5. The method of claim 1 wherein the plurality of tools comprises tools selected from the group consisting of wet chemical process tools, vacuum process tools, ion implant process tools, photolithographic process tools, deposition process tools, etch process tools and planarization process tools.

6. The method of claim 1 wherein the plurality of tools comprises planarization process tools.

7. The method of claim 1 wherein the tool utilization factor is provided in wafers per hour.

8. A method for fabricating a semiconductor product comprising:
providing a plurality of semiconductor fabrication facilities comprising a plurality of tools employed for fabricating a single semiconductor product, the plurality of tools being divided into a series of comparable tool groups;
determining for the plurality of tools a corresponding plurality of tool utilization factors when fabricating the single semiconductor product within the plurality of semiconductor fabrication facilities;
comparing a plurality of tool utilization factors for a specific comparable tool group to define an optimized tool utilization factor for the specific comparable tool group; and
developing and implementing revised operating procedures for the plurality of tools within the specific comparable tool group such that each tool within the specific comparable tool group operates at a tool utilization factor which approximates the optimized tool utilization factor for the specific comparable tool group.

9. The method of claim 8 wherein the plurality of microelectronic fabrication facilities is regionally geographically dispersed.

10. The method of claim 8 wherein the plurality of microelectronic fabrication facilities is globally geographically dispersed.

11. The method of claim 8 wherein the plurality of tools comprises tools selected from the group consisting of wet chemical process tools, vacuum process tools, ion implant process tools, photolithographic process tools, deposition process tools, etch process tools and planarization process tools.

12. The method of claim 8 wherein the plurality of tools comprises planarization process tools.

13. The method of claim 8 wherein the tool utilization factor is provided in wafers per hour.

14. A system for fabricating a microelectronic product comprising:
a plurality of microelectronic fabrication facilities comprising a plurality of tools employed for fabricating a single microelectronic product, the plurality of tools being divided into a series of comparable tool groups;
means for determining for the plurality of tools a corresponding plurality of tool utilization factors when fabricating the single microelectronic product within the plurality of microelectronic fabrication facilities;
means for comparing a plurality of tool utilization factors for a specific comparable tool group to define an optimized tool utilization factor for the specific comparable tool group; and
means for developing and implementing revised operating procedures for the plurality of tools within the specific comparable tool group such that each tool within the specific comparable tool group operates at a tool utilization factor which approximates the optimized tool utilization factor for the specific comparable tool group.

15. The system of claim 14 wherein the plurality of microelectronic fabrication facilities is regionally geographically dispersed.

16. The system of claim 14 wherein the plurality of microelectronic fabrication facilities is globally geographically dispersed.

17. The system of claim 14 wherein the microelectronic product is selected from the group consisting of a semiconductor product and a ceramic substrate product.

18. The system of claim 14 wherein the plurality of tools comprises tools selected from the group consisting of wet chemical process tools, vacuum process tools, ion implant process tools, photolithographic process tools, deposition process tools, etch process tools and planarization process tools.

19. The system of claim 14 wherein the plurality of tools comprises planarization process tools.

20. The system of claim 14 wherein the tool utilization factor is provided in wafers per hour.
